(19) United States
(12) Patent Application Publication
(10) Pub. No.: US 2008/0216939 A1
(43) Pub. Date: Sep. 11, 2008

(54) VERTICAL FEED SYSTEM FOR NON-SEAMED SHRINK LABELS

(76) Inventor: Richard A. Fearn, Cincinnati, OH (US)

Correspondence Address: THOMPSON HINE L.L.P.;Intellectual Property Group, P.O. BOX 8801, DAYTON, OH, 45401-8801, US

(21) Appl. No.: 11/681,936

(22) Filed: Mar. 5, 2007

(51) Int. Cl. B32B 37/00

(52) U.S. Cl. 156/86

(57) ABSTRACT

A container labeling system includes a vertical feed system. The vertical feed system includes a continuous roll of non-seamed shrink film material, where the non-seamed shrink film material shrinks in a cross-machine direction. A severing device is used to sever the non-seamed shrink film material into discrete lengths of non-seamed shrink material. A vertical feed mechanism transfers the discrete lengths of non-seamed shrink material toward a transport mechanism. A labeling apparatus receives the discrete lengths of non-seamed shrink material from the transport mechanism. The labeling apparatus is configured to form a tube from the discrete length of non-seamed shrink material and to apply the tube to a container for a shrinking operation.

### TECHNICAL FIELD

The present application relates to labeling systems, and more particularly to a vertical feed system for non-seamed shrink label web.

### BACKGROUND

Shrink sleeve labels are commonly applied to various container types. Typically, the shrink film material is pre-processed by forming a continuous tube from a continuous roll of shrink material having cross-machine direction shrink, forming a continuous joined seam along machine direction edges of the continuous roll of the shrink material and then rolling the continuous tube onto a roll for a later labelling operation. For example, conventional, vertical type, thermo-shrinking labeling machines utilize a continuous roll of tubular shrink material pre-processed as described above. The continuous tube may be advanced over a mandrel and then severed using a cutting device into discrete length tubes of the pre-formed continuous tube. The discrete length tubes are located about a container and then carried to a heating unit where the discrete length tubes are heated to shrink.

A horizontally fed labeling machine has been developed that utilizes a continuous roll of shrink film material having machine direction shrink. An unwind assembly unwinds the flat web of shrink material and a cutter cuts discrete lengths of the flat web material. A vacuum drum is used to transfer the discrete lengths using negative pressure onto a vacuum cylindrical member. A tubular label is formed by winding the discrete length of flat shrink material onto the cylindrical member which is also at negative pressure thereby overlapping cross-machine direction edges of the shrink material. The tubular label is then sealed along the overlapped edges by a sealing device and the tubular label is detached from the cylindrical member in order to allow the cylindrical member and a bottle to descend to a position where the tubular label is disposed about the bottle.

Commercially available machine direction shrink materials are typically used in low to medium shrink applications, which can exclude higher shrink applications such as long neck bottles. Therefore, in higher shrink applications, it may be desirable to employ a system capable of utilizing cross-machine direction shrink materials.

### SUMMARY

In an aspect, a container labeling system includes a vertical feed system. The vertical feed system includes a continuous roll of non-seamed shrink film material, where the non-seamed shrink film material shrinks in a cross-machine direction. A severing device is used to sever the non-seamed shrink film material into discrete lengths of non-seamed shrink material. A vertical feed mechanism transfers the discrete lengths of non-seamed shrink material toward a transport mechanism. A labeling apparatus receives the discrete lengths of non-seamed shrink material from the transport mechanism. The labeling apparatus is configured to form a tube from the discrete length of non-seamed shrink material and to apply the tube to a container for a shrinking operation.

In another aspect, a feed system for feeding non-seamed shrink film material to a labeling apparatus that forms the non-seamed shrink film into a tube and applies the tube to a container for a shrinking operation is provided. The feed system includes a continuous roll of non-seamed shrink film material, where the non-seamed shrink film material is configured to shrink in a cross-machine direction. A severing device severs the non-seamed shrink film material into discrete lengths of non-seamed shrink material. A vertical feed mechanism transfers the discrete lengths of non-seamed shrink material toward a transport mechanism. The transport mechanism is arranged and configured to transport the discrete lengths of the non-seamed shrink material toward the labeling apparatus to form tubes from the discrete lengths of non-seamed shrink material and to apply the tubes to containers for a shrinking operation.

In another aspect, a method of applying a tubular shrink label to a container is provided. The method includes providing a continuous roll of non-seamed shrink film material, the non-seamed shrink film material configured to shrink in a cross-machine direction. The non-seamed shrink film material is severed into discrete lengths of non-seamed shrink material. The discrete lengths of non-seamed shrink material are transported in a vertical direction toward a transport mechanism. The discrete lengths of non-seamed shrink material are transported from the transport mechanism to a labeling apparatus, the labeling apparatus forming a tube from the discrete length of non-seamed shrink material and applying the tube to a container for a shrinking operation.

Other advantages and features of the invention will be apparent from the following description of particular embodiments and from the claims.

### BRIEF DESCRIPTION OF DRAWINGS

FIG. 1 is a diagrammatic, unscaled top view of an embodiment of a method and apparatus for applying a shrink label to a container;

FIG. 2 is a perspective view of an embodiment of a continuous roll of non-seamed shrink material having cross-direction shrink;

FIG. 3 is a diagrammatic, front view of an embodiment of a vertical feed system; and

FIG. 4 is a diagrammatic, section view of an embodiment of a cylindrical member for use in forming a tube of non-seamed shrink material and applying the tube to a container.

### DESCRIPTION

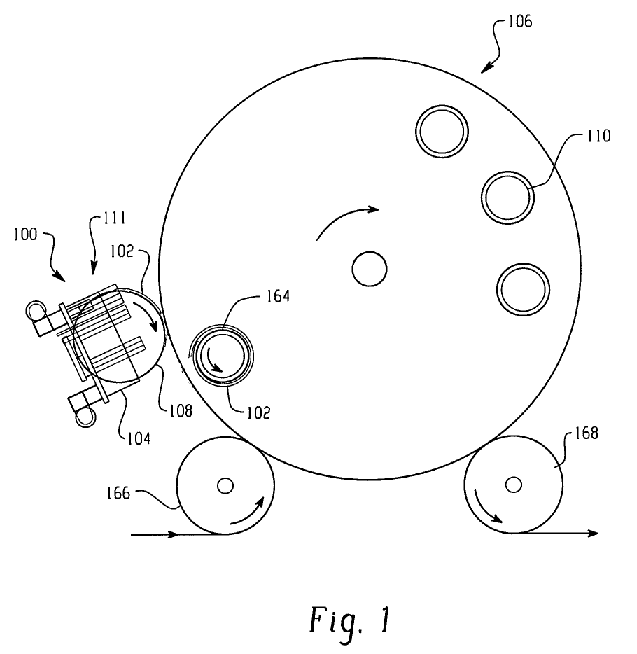

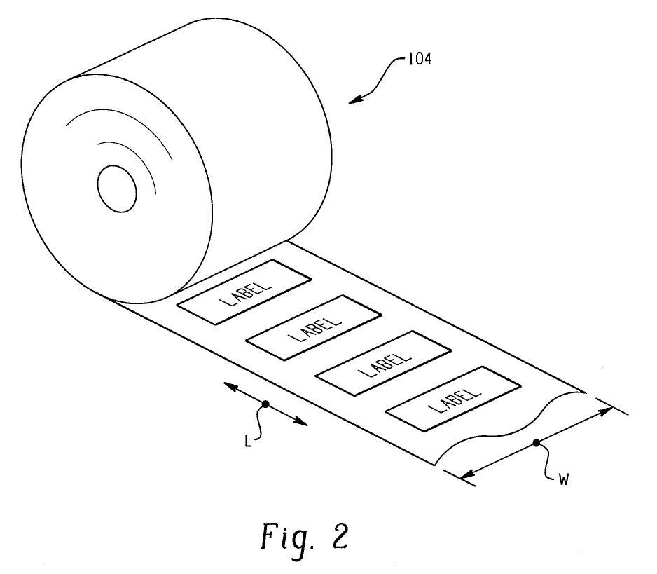

Referring to FIG. 1, a vertical feed system 100 forms discrete lengths 102 of non-seamed shrink material (i.e., flat shrink material formed of, for example, PVC, PET, PET-G, PS, PLA, etc.) having cross-machine direction (CD) shrink (e.g., at least about 60 percent CD shrink) from a continuous roll 104 and transfers the discrete lengths 102 of non-seamed shrink material to a labeling apparatus 106 using a drum 108. Referring briefly to FIG. 2, as used herein, “machine direction shrink” refers to a film material that can shrink in a direction substantially parallel to a continuous length L of the roll of the film material and “cross-machine direction shrink” refers to a film material that can shrink in a direction substantially transverse to the machine direction or substantially parallel to the width W of the film. It should be noted that while a film having CD shrink may also have some MD shrink (e.g., the film may be biaxially oriented), as used herein, referring to a film as having CD shrink means that the film's shrink is greater (e.g., at least 2 times greater or more) in the CD than in the MD or even that the film has been monoaxially oriented to shrink only in the CD. Likewise, referring to a film as having MD shrink means that the film's shrink is greater (e.g., at least 2 times greater or more) in the MD than in the CD.

Referring again to FIG. 1, as will be described in greater detail below, the vertical feed system 100 includes the roll 104 that is vertically oriented and a vertical feed and severing system 111 that is used to feed the non-seamed shrink material vertically from the roll, sever the discrete lengths 102 and locate the discrete lengths onto the drum 108. The labeling apparatus 106 is capable of forming seamed, tubular labels in line and inserting containers 110 within the tubular labels for a shrinking process. An exemplary labeling apparatus is described by U.S. application Ser. No. 10/524,771, entitled “Process and Apparatus for Forming Tubular Labels of Heat Shrinkable Film and Inserting Containers Therein,” the details of which are hereby incorporated by reference as if fully set forth herein.

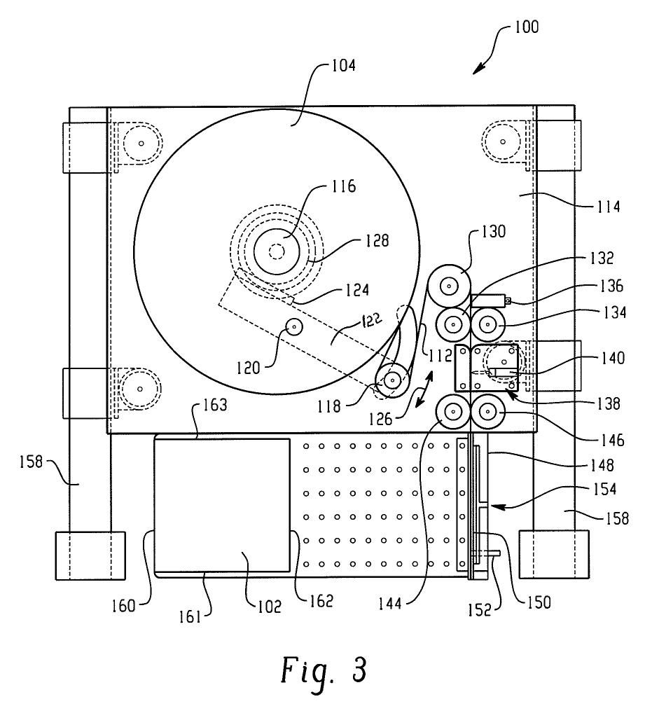

Referring to FIG. 3, vertical feed system 100 includes the continuous roll 104 of the non-seamed shrink material 112 that includes printed indicia thereon (e.g., labels). As indicated above, the non-seamed shrink material 112 is oriented to shrink in the CD and the continuous roll 104 is vertically oriented on a backing plate 114 as shown and mounted on an unwind spindle 116. The web of non-seamed shrink material 112 is threaded around a weighted dancer roller 118 that is connected to an arm 122. The arm 122 is connected to a pivot 120 and carries a brake pad 124 at an end opposite the dancer roller 118. Pivot 120 allows for movement of the dancer roller 118 up and down in the direction of arrow 126 so that as the web of non-seamed shrink material 112 slacks, the dancer roller 118 moves downward, which can cause the brake pad 124 to contact brake 128 thereby slowing rotation of the unwind spindle 116 to create increased web tension. In an alternative embodiment, a motor (not shown) may be used to advance the continuous roll 104. The motor may be connected to a controller (e.g., a microprocessor) and transducer that are used to control tension in the web of non-seamed shrink material. Another alternative embodiment may include a brake and clutch to control web tension.

The web of non-seamed shrink material 112 is further wrapped around an idler roller 130 and through drive nip rollers 132 and 134. A web sensor 136 is located adjacent the web 112. Web sensor 136 is used to detect a contrast (e.g., such as a printed mark) and provide a signal to a controller (not shown). Drive nip rollers 132 and 134 move the web of non-seamed shrink material 112 through a cutting station 138 that includes a cutting device 140 (e.g., knife, laser, rotary die, etc.) for cutting the web. The cutting device 140 is operated (e.g., using the controller) based on the signal provided by the web sensor 136 to provide a discrete length of web material (e.g., corresponding to a single printed label 102).

Once cut, the single printed label 102 is pulled from the cutting station 138 by high speed nip rollers 144 and 146. High speed nip rollers 144 and 146 operate at a higher speed than drive nip rollers 132 and 134. The high speed nip rollers 144 and 146 propel the single printed label 102 (e.g., at a minimum speed of at least about 1.5 times that of web 112) through a label guide 148, which helps to maintain the orientation of the single printed label, and into a label chute 150. Label guide 148 is shaped so as to inhibit single label 102 from wrapping around high speed nip rollers 144 and 146 or being deposited outside chute 150.

A label sensor 152 detects the presence of the single printed label 102 within the label chute 150 and provides a signal (e.g., to a controller) thereby indicating presence of the single printed label. The signal is used to trigger a compressed air device 154 (e.g., an air knife) that directs pressurized air against a leading edge of the single printed label 102 thereby forcing the leading edge of the single printed label against vacuum drum 108. The vacuum drum 108 then pulls the single printed label 102 from the label chute 150 and transfers the single printed label along a horizontal path where the single printed label is received by the labeling apparatus 106. Vertical feed system 100 is supported by a series of adjustable cross members 158 to allow for transport of various sized labels to the labeling apparatus.

As can be appreciated, the single printed label 102 is positioned on the vacuum drum 108 with its MD edges 160 and 162 oriented vertically and its CD edges 161 and 163 oriented horizontally. This orientation will allow the labeling apparatus 106 to form a tube from the single printed label 102 by overlapping the MD direction edges 160 and 162 and then seaming the tube at the MD edges for a CD shrinking operation.

Referring again to FIG. 1, the single printed label 102 is transferred from the vacuum drum 108 onto the cylindrical member 164. In some embodiments, the single printed label 102 is transferred to an intermediate vacuum drum (not shown) from the vacuum drum 108 and then onto the cylindrical member 164. The containers 110 are transported onto the cylindrical member 164 by an inlet conveyor 166. An outlet conveyor 168 is used for discharging the containers 110 to a heating tunnel (not shown) for heat shrinking a tubular label disposed thereabout onto the container.

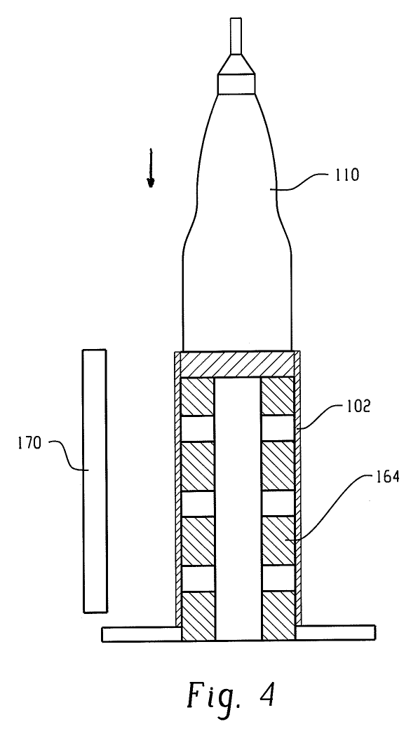

Referring to FIG. 4, a tube (or sleeve) is formed by overlapping MD edges 160 and 162 (see FIG. 3) of the single printed label 102 on the cylindrical member 164. A sealing device 170 (e.g., including a heat sealing bar) is used to seal the overlapped MD edges. Once the MD edges 160 and 162 are sealed, the tubular single printed label 102 is detached from the cylindrical member 164 through use of pressurized air in order to allow the cylindrical member 164 to descend from its illustrated risen position to a lowered position where the container 110 is lowered into the tube of the single printed label 102. The container 110 and tube of the single printed label 102 are then transferred to a heat treatment operation where the tube of the single printed label 102 shrinks down (e.g., at least about 60 percent) onto the container in the CD.

The above-described vertical feed system 100 allows for use of CD shrink film materials which may have higher shrink than many MD shrink materials. Additionally, there are many non-PVC CD shrink material options commercially available as compared to MD shrink materials, such as PET, PET-G, PS, PLA, etc.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application as expressed by any claims now included or hereafter added.

What is claimed is:

1. A container labeling system comprising:
a vertical feed system comprising
a continuous roll of non-seamed shrink film material, the non-seamed shrink film material configured to shrink in a cross-machine direction;
a severing device that severs the non-seamed shrink film material into discrete lengths of non-seamed shrink material;
a vertical feed mechanism that transfers the discrete lengths of non-seamed shrink material toward a transport mechanism; and
a labeling apparatus that receives the discrete lengths of non-seamed shrink material from the transport mechanism, the labeling apparatus configured to form a tube from the discrete length of non-seamed shrink material and to apply the tube to a container for a shrinking operation.

2. The container labeling system of claim 1 further comprising a tensioning system that is configured to maintain tension in the non-seamed shrink film material as the non-seamed material is removed from the continuous roll.

3. The container labeling system of claim 2 further comprising a brake arranged and configured to inhibit rotation of the continuous roll if tension in the non-seamed shrink film material falls below a preselected amount.

4. The container labeling system of claim 1 further comprising a label guide that receives the discrete lengths of the non-seamed shrink material from the vertical feed mechanism and maintains alignment of the discrete lengths of the non-seamed shrink material as they are received by the transport mechanism.

5. The container labeling system of claim 1, wherein the transport apparatus comprises a vacuum drum.

6. The container labeling system of claim 1 further comprising an unwind spindle that rotatably supports the continuous roll in a substantially vertical orientation with the unwind spindle extending substantially horizontally.

7. The container labeling system of claim 1, wherein the vertical feed system transfers the discrete lengths of non-seamed shrink material in a vertical direction toward the transport mechanism, the transport mechanism transporting the discrete lengths of non-seamed shrink material in a horizontal direction toward the labeling apparatus.

8. The container labeling system of claim 1, wherein the labeling apparatus is configured to form the tube from the discrete length of non-seamed shrink material by overlapping machine direction edges of the discrete length of non-seamed shrink material.

9. A feed system for feeding non-seamed shrink film material to a labeling apparatus that forms the non-seamed shrink film into a tube and applies the tube to a container for a shrinking operation, the feed system comprising:
a continuous roll of non-seamed shrink film material, the non-seamed shrink film material configured to shrink in a cross-machine direction;
a severing device that severs the non-seamed shrink film material into discrete lengths of non-seamed shrink material; and
a vertical feed mechanism that transfers the discrete lengths of non-seamed shrink material toward a transport mechanism, the transport mechanism arranged and configured to transport the discrete lengths of the non-seamed shrink material toward the labeling apparatus to form tubes from the discrete lengths of non-seamed shrink material and to apply the tubes to containers for a shrinking operation.

10. The feed system of claim 9 further comprising a tensioning system that is configured to maintain tension in the non-seamed shrink film material as the non-seamed is removed from the continuous roll.

11. The feed system of claim 10 further comprising a brake arranged and configured to inhibit rotation of the continuous roll if tension in the non-seamed shrink film material falls below a preselected amount.

12. The feed system of claim 9 further comprising a label guide that receives the discrete lengths of the non-seamed shrink material from the vertical feed mechanism and maintains alignment of the discrete lengths of the non-seamed shrink material as they are received by the transport mechanism.

13. The feed system of claim 9, wherein the transport apparatus comprises a vacuum drum.

14. The feed system of claim 9 further comprising an unwind spindle that rotatably supports the continuous roll in a substantially vertical orientation with the unwind spindle extending substantially horizontally.

15. The feed system of claim 9, wherein the vertical feed system transfers the discrete lengths of non-seamed shrink material in a vertical direction toward the transport mechanism, the transport mechanism transporting the discrete lengths of non-seamed shrink material in a horizontal direction toward the labeling apparatus.

16. A method of applying a tubular shrink label to a container, the method comprising:
providing a continuous roll of non-seamed shrink film material, the non-seamed shrink film material configured to shrink in a cross-machine direction;
severing the non-seamed shrink film material into discrete lengths of non-seamed shrink material;
transporting the discrete lengths of non-seamed shrink material in a vertical direction toward a transport mechanism; and
transporting the discrete lengths of non-seamed shrink material from the transport mechanism to a labeling apparatus, the labeling apparatus forming a tube from the discrete length of non-seamed shrink material and applying the tube to a container for a shrinking operation.

17. The method of claim 16, wherein the step of forming a tube from the discrete length of non-seamed shrink material includes overlapping machine direction edges of the discrete length of non-seamed shrink material.

18. The method of claim 17, wherein the step of forming a tube from the discrete length of non-seamed shrink material includes forming a seam at the overlapped machine direction edges of the discrete length of non-seamed shrink material.

19. The method of claim 16, wherein the step of transporting the discrete lengths of non-seamed shrink material from the transport mechanism to the labeling apparatus includes transporting the discrete lengths of non-seamed shrink material in a horizontal direction from the transport mechanism to the labeling apparatus.

20. The method of claim 16 further comprising shrinking the discrete lengths of non-seamed shrink material in their cross-machine direction after they are applied to containers.
